(19) United States
(12) Patent Application Publication
(10) Pub. No.: US 2014/0095265 A1
(43) Pub. Date: Apr. 3, 2014

(54) SYSTEM AND METHOD FOR PRODUCT VENDOR SELECTION

(71) Applicant: CAPITOL DEVELOPMENT LLC, SUNRISE, FL (US)

(72) Inventor: Robert J Steinman, Coral Springs, FL (US)

(73) Assignee: CAPITOL DEVELOPMENT LLC, SUNRISE, FL (US)

(21) Appl. No.: 13/828,426

(22) Filed: Mar. 14, 2013

Related U.S. Application Data
(60) Provisional application No. 61/707,934, filed on Sep. 29, 2012.

(51) Int. Cl. G06Q 10/06

(52) U.S. Cl. CPC G06Q 10/0637
USPC 705/7.36

(57) ABSTRACT

Systems and methods for facilitating complex purchasing decision across a plurality of potential product vendors are based on accumulating pricing, logistical (inventory, shipping, transport, etc.), and performance (past delivery timeliness, satisfaction, etc.) information from a spectrum of relevant sources (vendors, shippers, warehouses, distributors, manufacturers, etc.) and using linear optimization methods to identify one or more recommended vendors from whom to buy a given product at a given logistical moment. The linear optimization analysis is preferably further refined by considering vendor selection priorities of the purchaser, which may be either purchaser-specific or may be generalized to a category of purchaser (such as government versus private, employee size, etc.).

### RELATED APPLICATIONS

This application claims the benefit of U.S. provisional patent application No. 61/707,934 filed on Sep. 29, 2012, the contents of said provisional patent application being incorporated by reference to the fullest extent permitted by respective relevant patent offices.

### FIELD OF THE INVENTION

The present invention relates to the field of electronic commerce, generally, and more particularly, facilitating vendor selection in purchasing decisions.

### BACKGROUND OF THE INVENTION

Individuals who are responsible for cost-effective purchasing of supplies and the like, particularly high-volume purchases (such as pens or bolts, for example) available from many vendors, are faced with a complex combination of variables (beyond price alone) in trying to choose vendors from whom to buy items—best prices, vendor reliability, current vendor inventory, supplemental costs such as delivery, product equivalents between brands, and so forth.

For those working in government organizations (particularly, the US Federal Government), the foregoing economic/logistical factors are further complicated by complex and often interrelated regulatory requirements, such as requirements to purchase from domestic (“Made in the USA”) vendors, or quotas to make a certain percentage of purchases from, for example, small businesses or minority-operated businesses. There are also more basic regulatory requirements such as required minimum product specifications or maximum permissible per-unit costs.

When the plurality of variables is considered in combination, making purchases at an optimal cost using consistent standards becomes extremely burdensome for an individual decision maker. This difficulty is sometimes referred to and quantified in economic theory as “search costs,” which are generally costs incurred beyond the simple product purchase price, such as the time and effort expended to make a robust analysis of purchasing decisions.

Yet, at the other extreme, incorrect or poor vendor selection (possibly caused by insufficient consideration of purchasing choices) can lead not just higher than necessary product prices, but additional inconvenience, lost time, and inefficiency because of back orders (if insufficient inventory is not considered) and other stockout costs, and comparatively long delivery times.

Conventional electronic commerce technologies address some challenges in purchasing. For example, a number of conventional electronic-based systems and methods of product purchasing are known and used. However, beyond electronic implementation of purchasing itself, there remains a need to more efficiently analyze the numerous parameters underlying the choice of a vendor.

### SUMMARY OF THE INVENTION

The present invention relates to systems and methods, optionally forming part of a larger online electronic commerce purchasing system, for facilitating vendor choices in purchasing transactions. The present invention relates, particularly but not only, to transactions where desired products (as well as differently branded equivalent products and functionally similar products) are available from a plurality of vendors, each vendor being associated with respective logistical parameters such as typical delivery times, vendor reliability, etc. The present invention particularly relates to facilitating vendor selection, tailored to a product purchaser's particular vendor selection priorities, which may be either predefined and purchaser-selected, or purchaser-defined.

### BRIEF DESCRIPTION OF THE DRAWINGS

The present invention will be even better understood with reference to the accompanying figure(s), in which:

FIG. 1 is a schematic diagram illustrating an electronic product vendor selection system according to the present invention, and its electronic interconnections for obtaining product-related information from a plurality of commercial sources, and for exchanging information with a product purchaser.

### DETAILED DESCRIPTION OF THE INVENTION

The following detailed description of the present invention is meant to be illustrative and not limitative. Other embodiments are possible in accordance with the present invention, and modifications to those described herein are possible within the scope of the present invention, as defined by the claims appended hereto.

The present invention is directed to methods and systems for efficiently and automatically analyzing purchasing parameters related to prospective product purchase so as to recommend one or more product vendors from whom to buy the product.

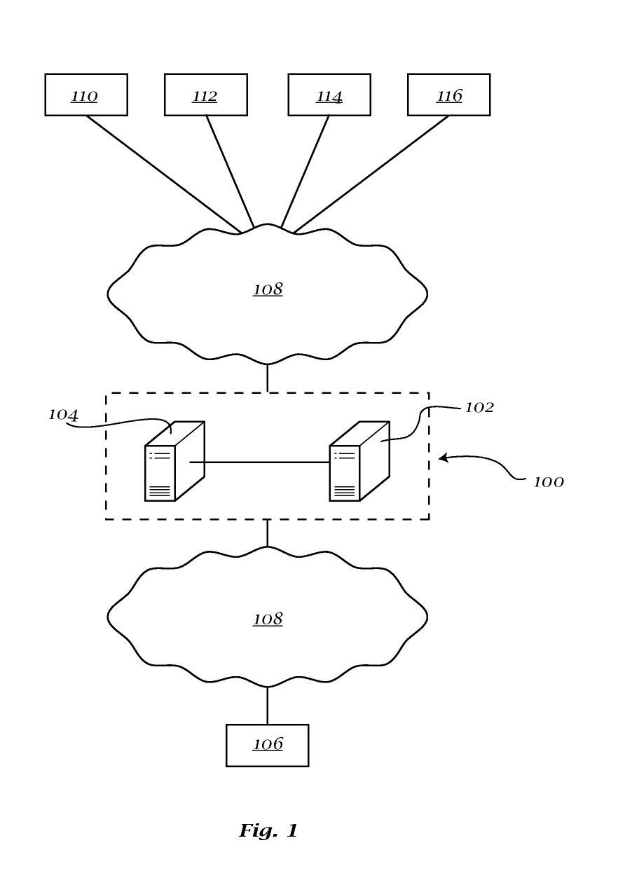

FIG. 1 illustrates an exemplary network arrangement according to the present invention. Although the arrangement in FIG. 1 illustrates a certain interconnection of the illustrated elements, it will be appreciated by a person skilled in the art that a variety of topographies are possible in accordance with the present invention while obtaining the underlying functionality of the invention. In particular, references herein to a first element being “connected to” or “communicating with” (or other like connectivity-related terminology) to a second element is specifically intended to encompass the concept of being “operably connected” thereto or “operably communicating with,” or in other words, to the possibility of intervening elements (including elements not necessarily expressly described herein) being disposed on the connection path between the first and second elements as long as the first and second elements have functional interaction.

As seen in FIG. 1, a system 100 for facilitating purchasing transactions is operably located in an electronic communication network 108 between one or more product purchasers 106 (one product purchaser being illustrated in FIG. 1 for simplicity, without limitation), and a plurality of commercial entities 110, 112, 114, 116 associated with one or more products to be purchased. Although four such entities are schematically illustrated in FIG. 1, more or fewer may actually be involved in a given situation.

Electronic communication network 108 may be any known communication network structure, including without limitation, a wide area network, a local area network, the Internet, and/or combinations thereof.

The system 100 comprises at least one communication server 102 for communicating as needed with the commercial entities 110, 112, 114, 116 and with the at least one product purchaser 106 via network 108. The at least one communication server may be any appropriately configured, conventional computer server adapted for electronic network communication. Instead of a server, as such, a different, appropriately configured network communication interface could be used in accordance with the present invention as contemplated, such as a conventional network router.

The system 100 also includes a central analysis computer server 104 for carrying out the accumulation of required information and the analysis thereof according to the present invention. The central analysis computer server 104 may be a conventionally available computer server, configured in accordance with the description of the present invention set forth herein. The at least one communication server 102 and the central analysis computer server 104 need not necessarily be physically separate components, and the functionality of one (particularly the at least one communication server 102) may be incorporated physically in the other, using known system integration approaches.

In one example, the commercial entities in communication with system 100 each controls, generates, or otherwise has information related to one or more products of interest to the product purchaser 106. For example (and without limitation), the commercial entities may be a manufacturer of the product 110 (possibly including manufacturers of differently branded identical products and/or manufacturers of products deemed to be functionally similar and/or refurbished versions of the product), one or more commercial distributors (typically, between the manufacturer and the vendor) 112 of the product, one or more product storage sites 114 (such as warehouses, depots, and the like), and one or more vendors 116 of the product from whom the product purchaser 106 actually purchases the product. As discussed in more detail below, communication with such a variety of commercial entities having information relevant to the purchase of a given product permits efficient access to a variety of relevant data related to the purchase of the product, which in turn leads to a more robust vendor recommendation, much improved beyond a simplistic direct comparison of, for example, the various product prices offered by respective vendors, taken alone.

For example, the product manufacturers 110 may provide product-specific (and possibly, vendor-independent) information, such as global trade item number information, related articles such as accessories (e.g., charger cords or adapters), product specifications and physical characteristics, physical attributes such as dimensions and weight. Information might also be provided regarding equivalent products and functionally similar products, optionally including information about differences.

Product distributors 112 can provide, for example, logistical information such as modes of shipment being used, and cost and availabilities thereof. Information such as shipping points and expected shipping times to a respective destination could also be provided.

Product storage sites 114 provide information regarding, for example, current product inventories in stock, locations of the inventories, and timing of expected resupplies.

Information from one or more product vendors 116 may include, for example, a proposed selling price for the product, promised delivery time for the instant purchase, price discounts, and number of deliveries anticipated to complete an order.

The foregoing description of various relevant data is strictly by way of example, and is not meant to be limitative or otherwise exclusive. Beyond the mention of the various kinds of data that can be used and considered according to the present invention, it is additionally meant to generally illustrate the potential quantity relevant data that can form the basis for analysis in identifying an optimal vendor from whom to purchase a product.

To the extent that many purchases include a plurality of sometimes very diverse products (each product being associated with a particular set of related information of the type discussed above), the number of combinations of relevant data is even larger. As a result, the amount of data that needs to be rapidly and accurately analyzed becomes very difficult to manage using conventional approaches.

To address this problem, the present invention contemplates an automated and electronic accumulation of the relevant product-related information from the commercial entities and using a dynamic linear optimization process to identify optimal combinations of factors resulting in one product vendor being preferable to another.

In order to further improve the analysis of vendor offerings, the underlying scoring of vendors is subject to weighting in view of particular priorities of a product purchaser in selecting a product vendor (e.g., a faster product delivery time could be more important than the lowest purchase price).

In an example according to the present invention, the commercial entities 110, 112, 114, 116 are each at least occasionally electronically connected to system 100 via network 108 using conventional network communication protocols. “At least occasionally connected” as used herein means either continuously connected or repeatedly connected for a limited time period then disconnected. With respect to the latter, the frequency of the connection may or may not be regular (or “periodic”).

More specifically, the system 100 may, for example, be operably connected with one or more databases, memories, data storage media or the like of a respective one of the commercial entities, where that commercial entity's relevant product-related information is stored. In one example of operation, the system 100 may interact with the computer systems of a respect commercial entity on a client-server basis, wherein relevant information is returned to and received by the system 100 in response to a client request. In another example of the invention, the commercial entity's relevant information may be systematically accumulated locally and held in a memory queue or the like for transmission to the system 100 when there is a connection with the system 100.

Most preferably, a common standard data “language” such as Extensible Markup Language (“XML”) is used for the product-related information received from the commercial entities. However, if needed, the system 100 may further include commercially available translation servers or other appropriately configured mechanisms (not illustrated) to translate a commercial entity's internally utilized data language (for example, the electronic data interchange protocol (“EDI”)) to, for example, XML.

In general, information can be electronically pushed, pulled, or both from the commercial entities to the system 100. In a particular example, the interaction between system 100 and the respective commercial entities could be on the basis of conventional database calls (as in SQL for example), assuming system 100 is given the necessary communication access. Alternatively, the commercial entities could install specific computer code configured to interact with system 100, such as a simple user interface specifically related to the system 100. In yet another example, the commercial entities can interact with system 100 via a website linked to the system 100, thereby providing a graphical interface for communicating information.

In the present invention, the information received from the commercial entities is the basic input in the process of automatically recommending a product vendor. The relevant analysis takes place at the central analysis computer server 104, which physically comprises one or more computer processors, one or more memories (RAM and/or ROM), and one or more interfaces, or combinations thereof in a known manner. Such servers are generally widely available from manufacturers such as Dell and Hewlett-Packard.

The central analysis computer 104 can be configured in any known manner to obtain the functionality of the present invention as set forth herein, but usually will be configured by providing appropriate computer code, which can either be permanently stored within the server (such as in read-only non-volatile memory), or by way of code provided on computer-readable media.

In one example, the functionality of the present invention can be provided by programming in, for example, the C# language using a software development platform like Microsoft.net. The functionality of the present invention can obtained by way of a multilayer functionality design, including:

a database layer (using conventional appropriate database applications such as SQL or Oracle) from which the product-related information is selectively retrieved;

a database interface layer for interfacing the analytic processes of the present invention with the database layer (for example, using an ado.net framework);

a presentation layer which generally provides the interface functionality with a user (e.g., the product purchaser) (can include a server-side web application framework, such as asp.net, for driving a web-based graphical user interface (such as dynamic webpages on a website), which are viewed on the user-side via a standard web browser (Explorer, Firefox, Safari, etc.) running on a computer or other terminal; and

a business layer that exists conceptually “between” the presentation layer and the database layer (and interface), in which the analytical rules of the present invention reside (e.g., an application program interface (“API”) design). The analytical processes required for the present invention are most generally a combination of various linear numerical equations to be optimized.

For example:

weighted price factor A=price x (for an equivalent product, 1.10; for an OEM product, 1.0)(worth 80% of the vendor's total score}; and

weighted price factor B=price x (if vendor rated 5 out of 5 then 1.0; if vendor rated 4 then 1.1)(worth 20% of the vendor's total score);

such that the total weighted price for that product-vendor-warehouse combination=(weighted price factor A*0.8)+(weighted price factor B*0.2).

The basic combination of numerical equations is preferably combined with vendor selection preferences/filters (e.g., only consider vendors having a consumer satisfaction rating of at least 4.0 out of 5.0; product delivery in x days or fewer is more important than cost, as long as the cost is less than y; systematically exclude vendors A, B, and C from consideration; only select vendors that can delivery today; etc.). These processes are carried out in the business layer of the computer code, as in the example above, and can potentially include an enormous number of consideration factors and very complex relationships.

The vendor selection priorities could be predefined and stored internally, such that the product purchaser 106 could select one of the predefined “sets” of vendor selection priorities that most closely corresponds with its profile and/or commercial situation, for example by communicating such a selection to the system 100 via network 108. The predefined selection priority sets could be defined according to, for example and without limitation, government versus non-government purchaser, size of purchase (individual, departmental/group level, agency/branch office level, government/company-wide). Using predefined vendor selection priorities can simplify the system as well as the product purchaser experience by avoiding the need for a given product purchaser to enter a plurality of personal vendor selection preferences.

However, it is even more useful to permit dynamic entry of a purchaser's vendor selection preferences. This ideally leads to an even more precise analysis of the available vendors and increases the likelihood that the recommended vendors will satisfactorily conform to the product purchaser's objectives. In this respect, the system 100 can initially be configured on a purchaser-by-purchaser basis with the purchaser's specific vendor selection priorities, such as via a webpage screen interface. For example, the system 100 can be configured to include a “set up” screen for the product purchaser 106. The arrangement of the interface is preferably graphic-intensive in order to facilitate use, for example, by way of graphical slider bars, boxes/buttons that can be click-toggled, and similar graphical input mechanisms meant to reduce the input of alphanumeric information.

The kinds of vendor selection preferences can be potentially be very diverse, particularly as a function of different product fields (mass purchases of pens versus grass seed, for example). One general category of preferences for example quantifies the relationship between delivery details and purchase price. This could be set out as prioritizing, for example, speed of delivery, an acceptable number of shipments to complete an order, an acceptable number of different vendors used to complete and order, past on-time performance, and a vendor's customer satisfaction rating. For example, a graphical slide bar indicating a 0-100% scale could be used for each preference and the purchaser can indicate the relative weight that should be placed on each preference in analyzing the product-related information (assuming that the total of the weightings should equal 100%).

Other preferences are more of a binary, or yes-no, indication of preference. For example, the purchaser can indicate whether a shipped product must be exactly the same model as selected by the purchaser, or whether the shipped product could acceptably be also a differently branded equivalent product. (A related preference that could be expressed is, for example, a maximum premium (expressed as a percentage over the price of the equivalent product) the purchaser is willing to pay in order to receive the originally selected version of the product instead of an equivalent.)

Preferences could also be entered (for example, by toggling radio buttons) to limit the vendor selection to certain socio-economic business structures (minority-owned businesses, small businesses, etc.), or to exclude certain vendors from consideration.

Again, the foregoing examples are merely intended to be illustrative and not limitative, and a skilled person will appreciate how other purchaser preferences in vendor selection could be taken into consideration in accordance with the foregoing description.

It will be appreciated that the definition of product purchaser vendor selection priorities or criteria can at least partly serve as a kind of filter (for example, when certain vendors are expressly excluded from consideration), that helpfully narrows the scope of information that is later subjected to linear optimization.

In a preferred example of the present invention, the preferences inputted by the purchaser 106 are received by the central analysis computer server 104 and each input preference datum is automatically used to “construct” relevant linear mathematical equations (a very simple example is “Total weighted price for the given product-vendor-warehouse combination=(weighted price factor A*0.8)+(weighted price factor B*0.2”) that will be subject to linear optimization by the system 100. The linear equations are weighted as appropriate (see the example above regarding the purchaser-prioritized selection of product delivery parameters) as is well-known in mathematics.

At this point, the product-related information received from the commercial entities, narrowed and/or refined in view of the vendor selection priorities being used, is reduced to a body of corresponding linear mathematical equations. The central analysis computer server is configured to consider the ensemble of these equations, subject to any mathematical constraints, and apply conventionally known linear optimization solutions solve for, for example, the lowest price of the product or combination of products being sought, which in turn implicates the preferred vendor.

### Working Example 1

To illustrate how the present invention can take into account a variety of criteria leading to selection of a preferred vendor, the following example can be considered.

If the product being purchased is, for example, laser printer toner, a first step in accordance with the present invention could be identifying an appropriate OEM laser printer toner product (for example, by manufacturer part number). Equivalent products (for example, those that will work with the laser printer in question but which are made by different manufacturers) may also be identified via information received from the commercial entities. Vendors from whom the OEM (and/or equivalent product manufacturer) product is available are then identified for each identified laser printer toner product. In turn, warehouse locations or other storage sources, associated with each respective vendor and where the laser printer toner product is stored, are identified.

Thereafter, in a particular example, vendors offering one-day shipping may be identified, taking into account the geographic relationship between the purchaser and the warehouses having sufficient inventory. Of those, the vendor offering the best price can be identified and presented to the product purchaser as a recommendation.

### Working Example 2

An exemplary U.S. Federal Governmental agency wants to cut its procurement costs and therefore requires that equivalent products must be considering in making purchases. However, a procurement specialist who is in the head office of the agency has researched office supplies, and concludes that Original Equipment Manufacturer (OEM) toner cartridges last 5% longer than equivalent types of toner. Furthermore, a local department of the agency has historically purchased several different brands of that toner (both OEM as well as equivalent products) from several sources (i.e., vendors). Some of the vendors have performed very well and some have not. In addition, the delivery times from the vendors have varied significantly; some inventory locations are quick to ship and deliver while others are very slow to process orders. These prior purchases have been done relatively randomly because it is difficult to evaluate the various relevant parameters in making purchasing decisions.

The present invention is therefore used with respect to a current purchase of, for example, laser toner compatible with a Hewlett-Packard laser printer. In setting up the business rules in the software interface, the agency globally selects price, delivery time, vendor rating, and the relevant warehouse's on-time performance in making a purchase decision, and the relative weight of these respective factors is also established. The present invention is further configured to let individual purchasers make selections themselves regarding the relationship between speed of delivery versus price (for example, because the purchaser is comparatively most knowledgeable regarding local requirements for speed of delivery).

In accordance with the written description of the invention, the agency's vendor selection preferences are converted in linear equations and saved by the system.

Examples of saved equations for this example could include:

Factor for Original OEM toner versus compatible toner: weighted price factor A=price x (if equivalent product then 1.0; if OEM product then (1.0/1.05))*(5.0/star rating of the product brand)(40% of the total score};

Factor for the vendor performance: weighted price factor B=price x(if vendor has 5-star rating then 1.0; if vendor has 4-star rating then 1.1; if vendor has 3-star rating then 1.2, if vendor has 2-star rating then 1.3, if vendor has 1-star rating then 1.4)(20% of total score);

Factor for the performance of the inventory location (e.g., a warehouse): weighted price factor C=price x*(5.0/star rating of the inventory location)(15% of total score); and

Factor for speed of delivery, with variable input by the purchaser at time of purchase: weighted price factor D=price x (User input between 1-10)*(days to deliver)(25% of total score).

Accordingly, the product-vendor-inventory location combination having the lowest total weighted score is selected or recommended. That is, the total weighted price for that product-vendor-inventory location combination=(weighted price factor A*0.4)+(weighted price factor B*0.2)+(weighted price factor C*0.15) +(weighted price factor D*0.25).

Thus in practice, a local agency employee uses the present invention to select the product that he needs for his printer. On a checkout page he is asked to confirm the his preferences for this particular order, where he indicates that delivery speed is very important for this particular purchase by moving the virtual sliding bar on the screen over to indicate a relatively high value for speed of delivery. The other agency-selected evaluation factors are automatically loaded for this purchase because the local agency employee does not have authority to change them.

The agency requests that all of their vendors, manufacturers, and their associated inventory locations (i.e., the “commercial entities” above) provide pricing, product, and stock level information via upload and automated connections. The past performance of the products, vendors, and inventory locations has been accumulated over.

### Working Example 3

A manufacturer has implemented a just-in-time system for the delivery of supplies needed in its manufacturing process. The manufacturer previously used three supply companies, but has determined that it could potentially use over 500 companies, with a combined total of 2500 warehouses, as sources of supply. The company's management wants to lower procurement costs and increase the number of on-time deliveries. The structure of the company is such that the head office approves potential suppliers, but “when to purchase” decisions are made at the factory department level.

The head office creates business rules in the system of the present invention that heavily weights or prioritizes speed of delivery. On-time delivery is paramount to the manufacturer because production must be stopped if supplies run out.

In accordance with the present invention, the following linear equations are defined based on the manufacturer's inputs:

Factor for speed of delivery, with variable input by the purchaser at time of purchase: weighted price factor A=price x*(purchaser input between 1-100*[days to deliver])(worth 50% of total score); and

Factor for the performance of the inventory location: weighted price factor B=price x*(10.0/star rating of the inventory location)(worth 50% of total score).

The product-vendor-inventory location with the lowest total weighted score is selected, where the total weighted price for that product-vendor-inventory location combination=(weight price factor A*0.5)+(weighted price factor B*0.5)

### Working Example 4

An oil company purchases various grades of oil and then refines the oil into gasoline. The oil composition varies from well to well, each with a unique mix of hydrocarbons, octane level, and sulfur content. The management of the company wants to preferably raise the octane level and lower the sulfur level in its purchased oil, and accordingly creates the following relationships using the present invention:

Factor for octane level: weighted price factor A=price x*(1/Octane level)(worth 70% of the total score);

Factor for sulfur content: weighted price factor B=price x*sulfur content*0.1(worth 30% of the total score);

Total weighted price for that product-vendor-inventory location combination=(weighted price factor A*0.7)+(weighted price factor B*0.3)

Although the present invention is described above with reference to certain particular examples for the purpose of illustrating and explaining the invention, it must be understood that the invention is not limited solely with reference to the specific details of those examples set forth above. More particularly, a person skilled in the art will readily understand and appreciate that modifications and developments that can be carried out without going beyond the ambit of the invention as defined in the claims appended hereto.

What is claimed is:

1. A system for facilitating purchasing transactions for a product purchaser relative to a plurality of potential product vendors, comprising:
at least one communication server connectable to an electronic communication network and being configured to at least occasionally receive product-related information from one or more of at least a product manufacturer, a product distributor, a product storage site, and one or more of the product vendors via the electronic communications network, and being additionally configured to communicate with the product purchaser via the electronic communication network;
a central analysis computer server having access to the product purchaser's vendor selection priorities and being operably connected to the at least one communication server, the central analysis computer being configured to automatically recommend one or more of the product vendors to the product purchaser for purchasing the product based on the uploaded product-related information and the product purchaser's vendor selection priorities.

2. The system of claim 1, wherein the electronic communication network comprises one or more of a wide-area network, a local area network, and the Internet.

3. The system of claim 1, wherein the product-related information is pushed, pulled, or both pushed and pulled to the at least one communication server.

4. The system of claim 1, wherein the central analysis computer server is connected to the at least one communication server via one or more of a local area network, a wide area network, and the Internet.

5. The system of claim 1, wherein the central analysis computer server, configured to automatically recommend one or more product vendors to the product purchaser, is configured to automatically score each product vendor based on one or more of a current logistical status and past performance information.

6. The system of claim 5, wherein the central analysis computer server configured to automatically recommend one or more product vendors is configured using computer readable code comprising instructions therefor.

7. The system of claim 5, wherein the current logistical status is quantified by one or more of current product inventory, price, differently-branded equivalent product availability, distance to the shipping point, and the number of shipping points available and the location of each relative to the purchaser, and the anticipated shipping time from each shipping point.

8. The system of claim 7, wherein the past performance information is quantified by past on time delivery performance information.

9. The system of claim 5, wherein the automatic scoring of each product vendor is weighted by the product purchaser's vendor selection priorities.

10. The system of claim 9, wherein the central analysis computer server is configured to have access to the product purchaser's vendor selection priorities by selectively receiving the product purchaser's vendor selection priorities from the product purchaser via the electronic communication network.

11. The system of claim 9, wherein the central analysis computer server is provided with one or more pre-defined product purchaser vendor selection priority sets.

12. The system of claim 11, wherein a pre-defined product purchaser vendor selection priority set can be selected by the product purchaser.

13. The system of claim 1, wherein the central analysis computer server is configured to use linear optimization to automatically recommend one or more product vendors to the product purchaser.

14. The system of claim 6, wherein the central analysis computer server is configured to use linear optimization to automatically score each product vendor.

15. A method of automatically recommending one or more product vendors to a product purchaser, comprising:
at least occasionally accumulating product-related information from one or more of at least a product manufacturer, a product distributor, a product storage site, and one or more of the product vendors using a communication server connected to an electronic communication network; and
using a central analysis computer server provided with the product purchaser's vendor selection priorities and operably connected with the communication server to automatically analyze the accumulated product-related information in combination with the product purchaser's vendor selection priorities by applying the product purchaser's vendor selection priorities to screen the accumulated product related-information and thereafter using linear optimization to automatically identify one or more recommended product vendors from whom to purchase the product.

16. The method according to claim 15, wherein the product-related information comprises current product inventory, price, differently-branded equivalent product availability, distance to the shipping point, the number of shipping points available and the location of each relative to the purchaser, and the anticipated shipping time from each shipping point.

17. The method according to claim 16, wherein the product purchaser vendor selection priorities include one or more of past vendor delivery performance, product performance, differently branded product equivalent preferences, functionally similar product preferences, vendor socio-economic business classification, minimum preferred product inventory level, product pack size, maximum preferred product delivery time, a vendor to be excluded from consideration, and preferred maximum number of deliveries to complete an order.

18. The method of claim 17, wherein the product purchaser's vendor selection priorities are grouped into a plurality of pre-defined product purchaser vendor selection priority sets, each corresponding with a respective generalized product purchaser profile.

19. The method of claim 18, wherein the generalized purchaser profile corresponds to one of a government purchaser and a non-government purchaser.

20. The method of claim 19, wherein the generalized purchaser profile corresponds to a respective one of: an individual purchaser, a department/division-level purchaser, an agency/company-level purchaser.

21. The method according to claim 18, further comprising providing a purchaser-selected product purchaser vendor selection priority set to the central analysis computer server.

22. The method according to claim 17, further comprising receiving vendor selection priorities input from the product purchaser on a per-purchase basis.

23. The method according to claim 17, wherein the vendor socio-economic business classification is one of a minority-owned business, service disabled military veteran-owned small business, a nonprofit institution, a female-owned business, a military veteran-owned business, a nonprofit institution, and an historically black college or university.
